(19) United States
(12) Patent Application Publication
(10) Pub. No.: US 2026/0292405 A1
(43) Pub. Date: Sep. 24, 2026

(54) SOUND DEVICE

(71) Applicant: LG ELECTRONICS INC., Seoul (KR)

(72) Inventors: Jongwoo KIM, Seoul (KR); Kihun KIM, Seoul (KR); Seunghark PAEK, Seoul (KR)

(73) Assignee: LG ELECTRONICS INC., Seoul (KR)

(21) Appl. No.: 18/874,199

(22) PCT Filed: Jan. 17, 2023
(86) PCT No.: PCT/KR2023/000765

§ 371 Date: Dec. 12, 2024

(30) Foreign Application Priority Data
Jun. 15, 2022 (KR) 10-2022-0072998

(51) Int. Cl. H04R 7/18; H04R 1/02; H04R 7/08

(52) U.S. Cl. CPC H04R 7/18; H04R 1/025; H04R 7/08

(57) ABSTRACT

A sound device is provided. The sound device of the present disclosure may include: a housing having an internal space; a speaker mounted at the housing; and a passive radiator spaced apart from the speaker and mounted at the housing, wherein the passive radiator may include: a diaphragm extending long, the diaphragm having a first end and a second end opposite each other in a longitudinal direction of the diaphragm; an edge extending along a perimeter of the diaphragm and coupled to the diaphragm and the housing; an upper supporter adjacent to the first end and protruding from the diaphragm and the edge; and a lower supporter adjacent to the second end and protruding from the diaphragm and the edge.

### TECHNICAL FIELD

The present disclosure relates to a sound device.

### BACKGROUND ART

A speaker is a device that converts an electro-acoustic signal to a sound wave and outputs the sound wave. The speaker may be divided into a woofer, a midrange, a tweeter, or the like according to a sound range. A passive radiator may reinforce low-frequency sounds of a sealed speaker. The passive radiator includes a diaphragm and an edge with no magnet, voice coil, and the like included therein.

Recently, many studies are being conducted on a structure for improving sound or low-frequency sound of a sound device having a speaker and a passive radiator.

### DETAILED DESCRIPTION OF INVENTION

### Technical Problems It is an objective of the present disclosure to solve the above and other problems.

Another objective may be to provide a sound device capable of providing high sound quality.

Another objective may be to provide a structure for minimizing non-uniform vibration of a passive radiator having an elongated diaphragm.

Another objective may be to provide a supporter capable of minimizing rolling and/or pitching of an elongated diaphragm.

Another objective may be to provide various examples of the structure and shape of a supporter included in a passive radiator.

### Technical Solution

In accordance with an aspect of the present disclosure for achieving the above and other objectives, a sound device may include: a housing having an internal space; a speaker mounted at the housing; and a passive radiator spaced apart from the speaker and mounted at the housing, wherein the passive radiator may include: a diaphragm extending long, the diaphragm having a first end and a second end opposite each other in a longitudinal direction of the diaphragm; an edge extending along a perimeter of the diaphragm and coupled to the diaphragm and the housing; an upper supporter adjacent to the first end and protruding from the diaphragm and the edge; and a lower supporter adjacent to the second end and protruding from the diaphragm and the edge.

### Effect of Invention

The sound device according to the present disclosure has the following effects.

According to at least one of the embodiments of the present disclosure, a sound device capable of providing high sound quality may be provided.

According to at least one of the embodiments of the present disclosure, a structure for minimizing non-uniform vibration of a passive radiator having an elongated diaphragm may be provided.

According to at least one of the embodiments of the present disclosure, a supporter capable of minimizing rolling and/or pitching of an elongated diaphragm may be provided.

According to at least one of the embodiments of the present disclosure, various examples of the structure and shape of a supporter included in a passive radiator may be provided.

Further scope of applicability of the present disclosure will become apparent from the detailed description given hereinafter. However, it should be understood that the detailed description and specific examples, while indicating preferred embodiments of the present disclosure, are given by illustration only, since various changes and modifications within the spirit and scope of the present disclosure will become apparent to those skilled in the art from this detailed description.

### BRIEF DESCRIPTION OF THE DRAWING

FIGS. 1 to 13 are diagrams illustrating examples of a sound device according to embodiments of the present disclosure.

### MODE FOR CARRYING OUT THE INVENTION

Hereinafter, the present disclosure will be described in detail with reference to the accompanying drawings, in which the same reference numerals are used throughout the drawings to designate the same or similar components, and a redundant description thereof will be omitted.

The suffixes, such as “module” and “unit,” for elements used in the following description are given simply in view of the ease of the description, and do not have a distinguishing meaning or role.

In addition, it will be noted that a detailed description of known arts will be omitted if it is determined that the detailed description of the known arts can obscure the embodiments of the present disclosure. Further, the accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that, although the terms first, second, etc., may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

A singular representation may include a plural representation unless context clearly indicates otherwise.

It should be understood that the terms “comprise,” “include,” “have,” etc. when used in this specification, specify the presence of stated features, integers, steps, operations, elements, components, or combinations thereof but do not preclude the presence or addition of one or more other features, integers, steps, operations, elements, components, or combinations thereof.

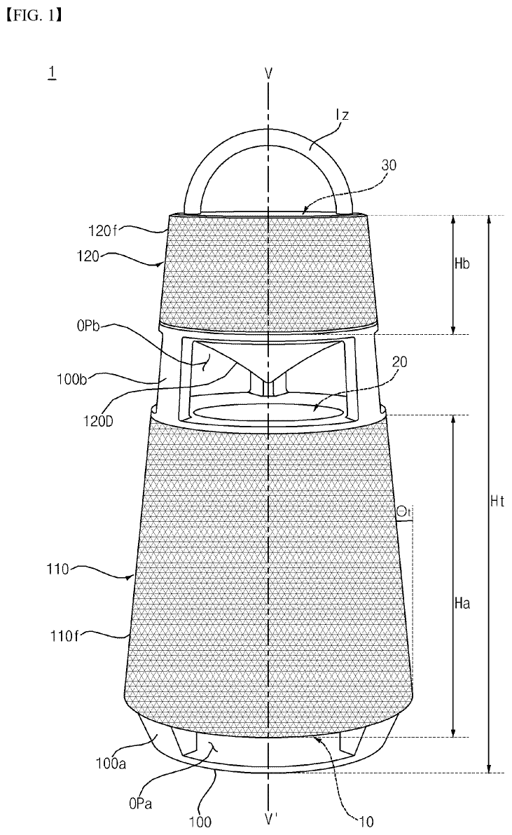

The configuration, shape, and the like of a sound device according to the present disclosure will be described below by using, as an example, a sound device which will be described below with reference to FIG. 1 and the like, but the sound device of the present disclosure is not limited thereto. That is, as long as the sound device includes a speaker, a passive radiator, and a housing in which they are mounted, the sound device of the present disclosure may have different configurations, shapes, and the like from the sound device that will be described below with reference to FIG. 1 and the like.

Referring to FIG. 1, a sound device 1 may be vertically elongated. The sound device 1 may have a generally bell shape. The sound device 1 may be referred to as a speaker assembly 1. The sound device 1 may include a base 100, a lower body 110, and an upper body 120.

The base 100 may be placed on the ground. The base 100 may have a generally circular plate shape. An upper surface of the base 100 may be convex upward.

The lower body 110 may be spaced upward from the base 100. The lower body 110 may have a generally truncated cone shape. A lateral side of the lower body 110 may be inclined by a predetermined angle theta t with respect to a vertical line. For example, a cover 110f may form the lateral side of the lower body 110. First columns 100a may be disposed between the base 100 and the lower body 110 and may be adjacent to the circumference of the base 100. The first columns 100a may be spaced apart from each other in a circumferential direction of the base 100 and may be coupled to the base 100 and the lower body 110. A first opening OPa may be formed between the first columns 100a and may be an exit of a space formed between the base 100 and the lower body 110. The lower body 110 may be referred to as a lower case 110, a first case 110, or a first housing 110.

An upper body 120 may be spaced upward from the lower body 110. The upper body 120 may have a generally truncated cone shape. An angle between a lateral side of the upper body 120 and a vertical line may be theta t. For example, a cover 120f may form the lateral side of the upper body 120. Second columns 100b may be disposed between the lower body 110 and the upper body 120 and may be adjacent to the circumference of the lower body 110. The second columns 100b may be spaced apart from each other in a circumferential direction of the lower body 110 and may be coupled to the lower body 110 and the upper body 120. A second opening OPb may be formed between the second columns 100b and may be an exit of a space formed between the lower body 110 and the upper body 120. The upper body 120 may be referred to as an upper case 120, a second case 120, or a second housing 120.

Meanwhile, a phase plug 120D may protrude from a lower side of the upper body 120 toward the lower body 110 and may have a downward convex shape. A lower end of the phase plug 120D may spaced upward from an upper side of the lower body 110. The phase plug 120D may be referred to as a diaphragm 120D or a sound guide 120D.

A height Ht of the aforementioned sound device 1 may be defined as a distance between the lower side of the base 100 and the upper side of the upper body 120. A height Ha of the lower body 110 may be greater than a height Hb of the upper body 120. For example, the height Ha of the lower body 110 may be greater than a half of the height Ht of the sound device 1. For example, the height Hb of the upper body 120 may be smaller than a half of the height Ha of the lower body 110.

A first speaker 10 may be installed inside the lower body 110 and may form a portion of the lower side of the lower body 110. The first speaker 10 may provide sound toward the base 100. For example, the first speaker 10 may be a woofer reproducing low frequency sounds. The sound from the first speaker 10 may be reflected horizontally by the upper surface of the base 100 that is convex upward, and may pass through the first opening OPa between the first columns 100a. That is, the sound device 1, having omnidirectionality, may provide sound in 360 degrees in the horizontal direction through the first speaker 10.

A second speaker 20 may be installed inside the lower body 110 and may form a portion of the upper side of the lower body 110. The second speaker 20 may provide sound toward the upper body 120. For example, the second speaker 20 may be a midrange reproducing middle frequency sounds. The sound from the second speaker 20 may be reflected horizontally by the phase plug 120D that is convex downward, and may pass through the second opening OPb between the second columns 100b. That is, the sound device 1, having omnidirectionality, may provide sound in 360 degrees in the horizontal direction through the second speaker 20.

A third speaker 30 may be installed inside the upper body 120. The third speaker 30 may provide sound toward the lateral side of the upper body 120. For example, the third speaker 30 may be a tweeter reproducing high frequency sounds.

Meanwhile, a handle 1z may have a generally open ring shape. A first end and a second end of the handle 1z may be adjacent to the circumference of the upper body 120 and may be fixed to the upper side of the upper body 120.

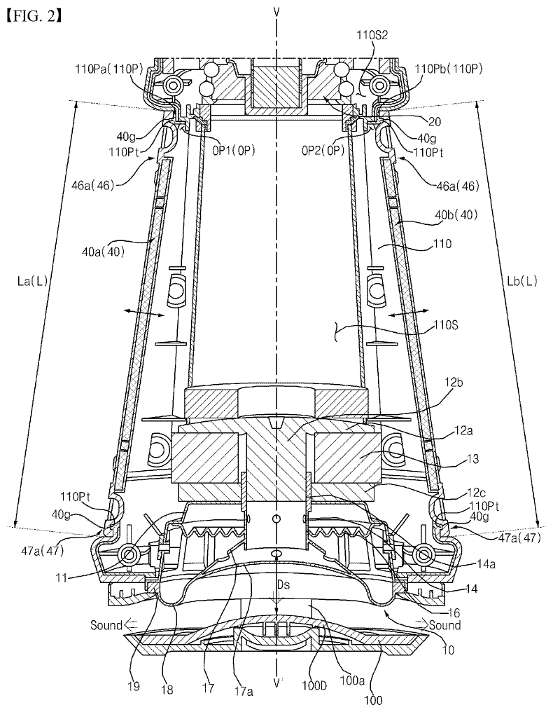

Referring to FIG. 2, the lower body 110 may provide an internal space 110S in which the first speaker 10 is installed. The second speaker 20 may be installed in a space 110S2 of the lower body 110 which is provided independently of the internal space 110S. The lower body 110 may be referred to as a housing 110 or an enclosure 110, and the first speaker 10 may be referred to as a speaker 10 or a loudspeaker 10. The speaker 10 may include a frame 11, a first plate 12a, a pole piece 12b, a second plate 12c, a magnet 13, a bobbin 14, a coil 14a, a spider 16, a diaphragm 17, and an edge 18.

The frame 11 may form the exterior of the speaker 10. The frame 11 may provide a space in which the components of the speaker 10, which will be described below, are installed. The frame 11 may be fixed to the inside of the housing 110.

The first plate 12a may form the upper side of the speaker 10. The pole piece 12b may protrude downward from a central portion of the first plate 12a, and may have a hollow cylinder shape or a solid cylinder shape. The second plate 12c may be spaced downward from the first plate 12a and may have a ring shape. In this case, a portion of the pole piece 12b may pass through the second plate 12c, and an air gap (not numbered) may be formed between the pole piece 12b and the second plate 12c.

The magnet 13 may be disposed between the first plate 12a and the second plate 12c and may have a ring shape. In this case, a portion of the pole piece 12b may pass through the magnet 13. The bobbin 14 may be disposed in the air gap and may have a hollow cylinder shape that vertically extends. The coil 14a may be formed on or wound around an outer circumferential surface of the bobbin 14 and may be referred to as a voice coil 14a. For example, terminals and tinsel wire may transfer electric energy, output from an amplifier in the housing 110, to the coil 14a.

The spider 16 may have elasticity. The spider 16 may be disposed between the bobbin 14 and the frame 11, may be coupled to the bobbin 14 and the frame 11, and may support the bobbin 14. The spider 16 may be referred to as a damper 16.

One side of the diaphragm 17 may be coupled or attached to the bobbin 14, and another side of the diaphragm 17 may be supported by the edge 18 having elasticity. For example, the diaphragm 17 may have a cone or dome shape. A gasket 19 may be provided on a lateral surface of the edge 18, and may prevent interference of peripheral devices with respect to the vibrating diaphragm 17. A dust cap 17a may cover the central portion of the diaphragm 17 and may prevent dust and the like from entering a magnetic circuit.

Accordingly, a magnetic line of force is formed in the air gap by the magnet 13, and Lorentz force is generated when a current flows through the coil 14a. The magnitude of Lorentz force is proportional to the magnitude of the magnetic line of force (magnetic flux density), the amount of electric current, and the length of the wound coil, and the direction of force may be perpendicular to the plane formed by the magnetic flux density and the current. That is, the diaphragm 17 may vibrate vertically. When the diaphragm 17 moves downward, positive (+) sound pressure is generated, and when the diaphragm 17 moves upward, negative (−) sound pressure is generated, thereby allowing the speaker 10 to provide sound in a direction toward the lower side of the speaker 10.

The air present in the internal space 110S of the housing 110 also resonates with the vibration of the diaphragm 17, such that the pressure thereof may be changed. In this case, a passive radiator 40 which will be described below may vibrate in response to a change in pressure of the air in the internal space 110S, and may produce sound.

Meanwhile, a dome 100D may form a portion of the upper surface of the base 100, and may be convex toward the central portion of the diaphragm 17 or the dust cap 17a. The dome 100D and the dust cap 17a may be vertically spaced apart from each other (see Ds of FIG. 2). Accordingly, the sound from the speaker 10 may be reflected horizontally by the dome 100D.

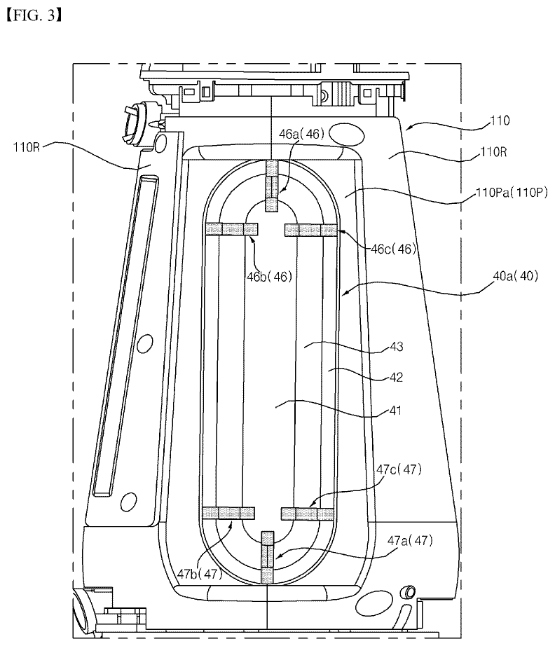

Referring to FIGS. 2 and 3, an opening OP may be formed through the lateral side of the housing 110, and the passive radiator 40 may be mounted to the housing 110 and may block the opening OP. The passive radiator 40 may have a shape corresponding to the opening OP. The passive radiator 40 may be spaced apart from the speaker 10 and may seal the internal space 110S of the housing 110 together with the speaker 10. An upper end of the passive radiator 40 may be adjacent to an upper end of the housing 110, and a lower end of the passive radiator 40 may be adjacent to a lower end of the housing 110. An area of the passive radiator 40 may be about twice an area of the diaphragm 17 of the speaker 10.

The lateral surface of the housing 110 may have a curved portion 110R and a flat portion 110P. The passive radiator 40 may be mounted on the flat portion 110P and may extend in a direction (see theta t of FIG. 1) in which the lateral surface of the housing 110 is inclined with respect to a vertical line. The aforementioned opening OP may be formed through the flat portion 110P.

For example, a plurality of passive radiators 40 may be spaced apart from each other in a circumferential direction of the housing 110. A sum of areas of the plurality of passive radiators 40 may be about twice the area of the diaphragm 17 of the speaker 10. For example, a pair of passive radiators 40a and 40b may be spaced 180 degrees apart from each other in the circumferential direction of the housing 110. For example, the pair of radiators 40a and 40b may be symmetric to each other with respect to a central axis VV′ of the sound device. A first passive radiator 40a may be mounted on a first flat portion 110Pa and may block a first opening OP1 formed in the first flat portion 110Pa. A second passive radiator 40b may be mounted on a second flat portion 110Pb and may block a second opening OP2 formed in the second flat portion 110Pb.

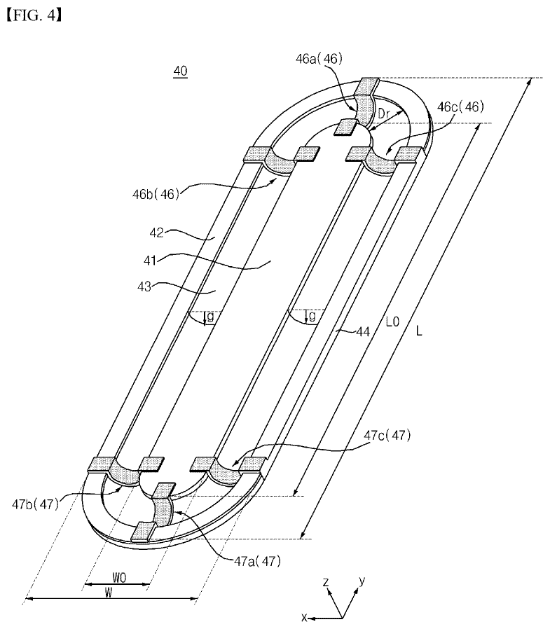

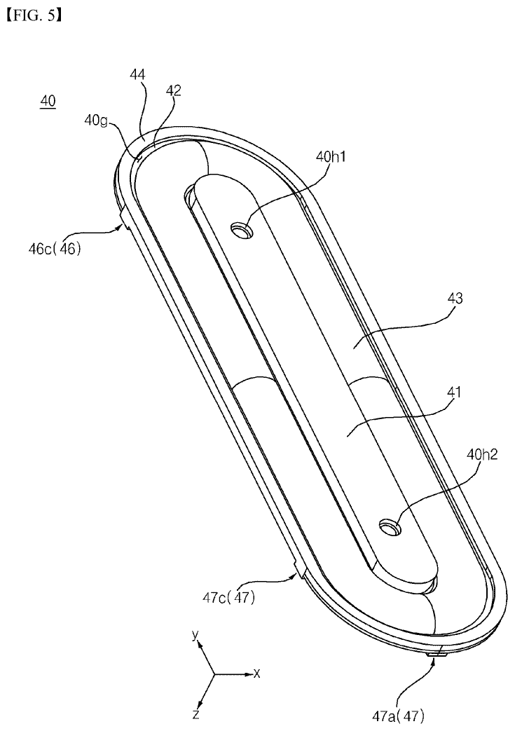

Referring to FIGS. 4 and 5, the passive radiator 40 may be elongated. A length L of the passive radiator 40 may be greater than a width W of the passive radiator 40. For example, the length L may be about three times greater than the width W. For example, the passive radiator 40 may have a generally elongated track shape. The passive radiator 40 may include a diaphragm 41 and edges 42 and 43. The edges 42 and 43 may be referred to as dampers 42 and 43 and surrounds 42 and 43.

The diaphragm 41 may form the central portion of the passive radiator 40. The diaphragm 41 may be elongated. A length L0 of the diaphragm 41 may be about 7 times greater than a width WO of the diaphragm 41. For example, the diaphragm 41 may have a shape corresponding to the passive radiator 40. For example, the diaphragm 41 may have a generally elongated track shape.

The edges 42 and 43 may have elasticity. The edges 42 and 43 may protrude from the lateral side of the diaphragm 41 to the outside of the diaphragm 41. A flange 42 may be spaced apart from the diaphragm 41 (see Dr of FIG. 4), and may form the circumference of the passive radiator 40. In the width direction of the diaphragm 41, the flange 42 may be disposed parallel to the diaphragm 41. A groove 43 is formed by being recessed from one surface (outer surface) of the passive radiator 40 toward another surface (inner surface) thereof (see g of FIG. 4) and may extend along the circumference of the diaphragm 41. The groove 43 may be formed between the diaphragm 41 and the flange 42 and may connect the diaphragm 41 and the flange 42.

A rib 44 may be adjacent to a distal end of the flange 42, may protrude from the rear of the flange 42, and may extend in a circumferential direction of the flange 42. An insertion groove 40g may be formed between the rib 44 and the groove 43. The insertion groove 40g may be locked by a protrusion 110Pt (see FIG. 2) of the flat portion 110P, and the rib 44 may be coupled or attached to the flat portion 110P. Accordingly, the passive radiator 40 may be mounted to the flat portion 110P.

In this case, the diaphragm 41 and the groove 43 of the passive radiator 40 may pass through the opening OP and may be directed toward the internal space 110S of the housing 110 (see FIG. 2).

Meanwhile, gates 40h1 and 40h2 (see FIG. 5) may or may not be formed on the rear surface of the diaphragm 41.

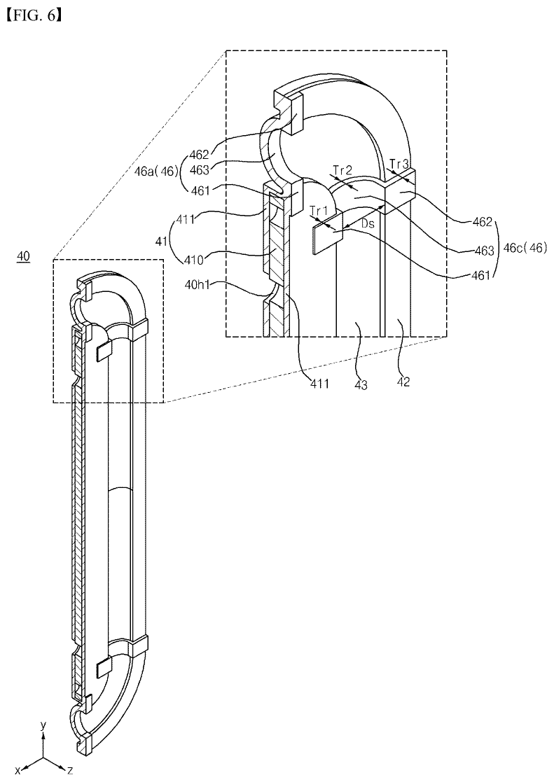

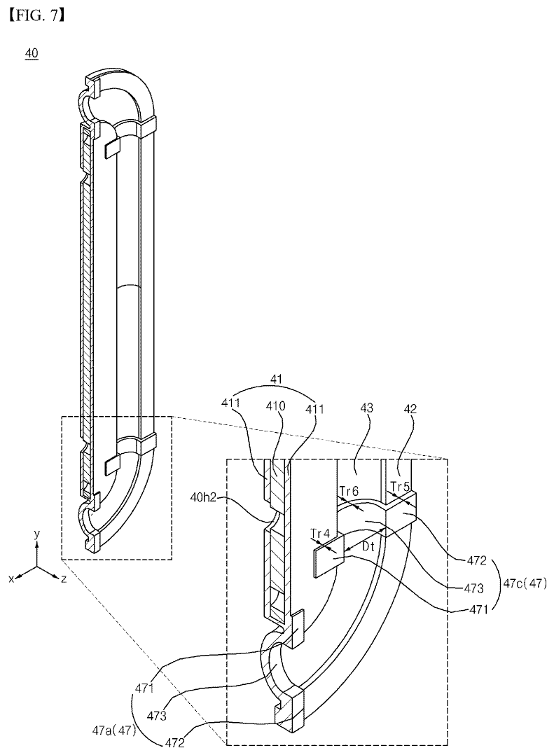

Referring to FIGS. 6 and 7, the diaphragm 41 may include a core 410 and a cover 411. The core 410 may have a shape corresponding to the overall shape of the diaphragm 41. The cover 411 may be thin and may cover the core 410. For example, the core 410 may be a metal plate of zinc alloy or other material. For example, the cover 411 may include rubber, silicone or resin material. For example, the edges 42 and 43 may include the same material as that of the cover 411. For example, the cover 411 may be formed as one body with the edges 42 and 43.

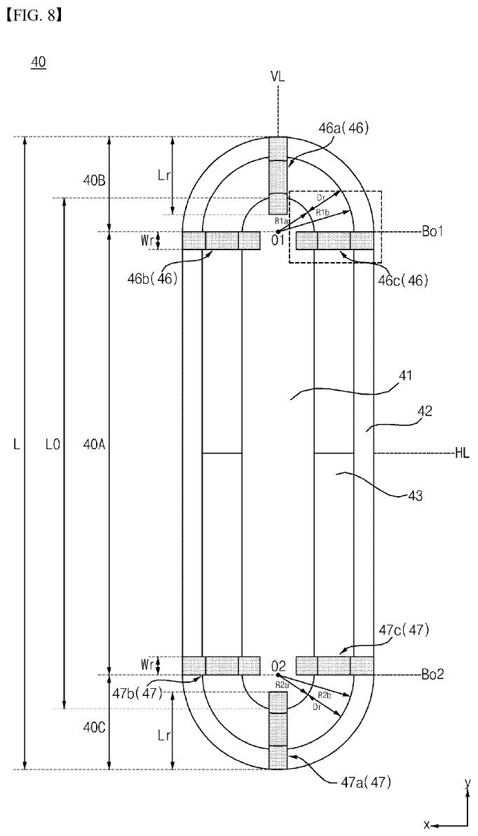

Referring to FIG. 8, the passive radiator 40 may include a straight section 40A, a first curved section 40B, and a second curved section 40C in a longitudinal direction of the passive radiator 40. A length of the straight section 40A may be greater than the sum of a length of the first curved section 40B and a length of the second curved section 40C. A width of the straight section 40A, a width of the first curved section 40B, and a width of the second curved section 40C may be equal to each other.

The straight section 40A may extend straight in the longitudinal direction of the passive radiator 40. In the straight section 40A, the diaphragm 41 may have a long square bar shape in the longitudinal direction of the passive radiator 40. In the straight section 40A, the flange 42 may have a long band shape in the longitudinal direction of the passive radiator 40. In the straight section 40A, the groove 43 may have a long semicylindrical shape in the longitudinal direction of the passive radiator 40.

The first curved section 40B may be connected to one end of the straight section 40A. The first curved section 40B may extend in a rounded manner. In the first curved section 40B, the diaphragm 41 may have a semicircular shape that is convex in a direction opposite to the straight section 40A. In the first curved section 40B, the flange 42 may have an upwardly convex band shape. In the first curved section 40B, the groove 43 may have an inverted U-shape that extends along the diaphragm 41 and the flange 42.

A center of curvature 01 of the first curved section 40B may be located at the center of a boundary Bo1 between the straight section 40A and the first curved section 40B. The center of curvature 01 may be referred to as a first center of curvature 01, and the boundary Bo1 may be referred to as a first boundary Bo1. In the first curved section 40B, a difference between a radius R1b of an inner circumferential surface of the flange 42 and a radius R1a of the diaphragm 41 may be equal to the width Dr of the groove 43.

The second curved section 40C may be connected to another end of the straight section 40A. The second curved section 40C may extend in a rounded manner. In the second curved section 40C, the diaphragm 41 may have a semicircular shape that is convex in a direction opposite to the straight section 40A. In the second curved section 40C, the flange 42 may have a downwardly convex band shape. In the second curved section 40C, the groove 43 may have a U-shape that extends along the diaphragm 41 and the flange 42.

A center of curvature 02 of the second curved section 40C may be located at the center of a boundary Bo2 between the straight section 40A and the second curved section 40C. The center of curvature 02 may be referred to as a second center of curvature 02, and the boundary Bo2 may be referred to as a second boundary Bo2. In the second curved section 40C, a difference between a radius R2b of an inner circumferential surface of the flange 42 and a radius R2a of the diaphragm 41 may be equal to the width Dr of the groove 43.

A vertical axis VL may pass through the center of the passive radiator 40 to extend in the length direction of the passive radiator 40. The passive radiator 40 may be laterally symmetric about the vertical axis VL. A horizontal axis HL may pass through the center of the passive radiator 40 to extend in the width direction of the passive radiator 40. The passive radiator 40 may be vertically symmetric about the horizontal axis HL. That is, the first curved section 40B and the second curved section 40C may be vertically symmetric about the horizontal axis HL.

Referring back to FIGS. 6 and 8, an upper supporter 46 may be adjacent to the upper end of the diaphragm 41 and may protrude from one surface of the passive radiator 40 in the thickness direction of the passive radiator 40. The upper supporter 46 may be made of the same material as that of the passive radiator 40 and may be formed as one body with the passive radiator 40. The upper supporter 46 may be positioned or aligned radially with respect to the first center of curvature 01. The upper supporter 46 may be formed on the diaphragm 41, the flange 42, and the groove 43. The upper supporter 46 may be referred to as an upper weight 46. The upper supporter 46 may include a first part 461, a second part 462, and a third part 463. A length Lr of the upper supporter 46 may be 21.5 mm.

The first part 461 may protrude from one surface of the diaphragm 41 in the thickness direction of the diaphragm 41. The second part 462 may protrude from one surface of the flange 42 in the thickness direction of the flange 42. The third part 463 may protrude from one surface of the groove 43 in the thickness direction of the groove 43. The first part 461 and the second part 462 may have a flat block shape. The third part 463 may have a curved shape along the groove 43, and may connect the first part 461 and the second part 462. The first part 461, the second part 462, and the third part 463 may be substantially in the shape of the Greek letter omega.

The first part 461, the second part 462, and the third part 463 may be formed as one body. The first part 461, the second part 462, and the third part 463 may be formed as one body with the diaphragm 41, the flange 42, and the groove 43, respectively.

Further, a thickness Tr1 of the first part 461, a thickness Tr2 of the second part 462, and a thickness Tr3 of the third part 463 may be equal to or different from each other. For example, the thicknesses Tr1, Tr2, and Tr3 may be 1 mm. For example, the thickness Tr1 of the first part 461 may be a minimum thickness of the upper supporter 46. For example, a distance Ds between the first part 461 and the second part 462 may be equal to a value obtained by subtracting twice the thickness Tr3 of the third part 463 from the width Dr of the groove 43.

In addition, the width of the first part 461, the width of the second part 462, and the width of the third part 463 may be equal to (see Wr of FIG. 8) or different from each other. For example, the width Wr may range from 4 mm to 10 mm. For example, the width Wr may be 5 mm.

For example, a plurality of upper supporters 46 may be spaced apart from each other in a circumferential direction of the first curved section 40B. For example, an angle between the plurality of upper supporters 46 may be constant in the circumferential direction of the first curved section 40B. For example, an angle between the three upper supporters 46a, 46b, and 46c may be 90 degrees in the circumferential direction of the first curved section 40B.

A first upper supporter 46a may be located on the vertical axis VL and may be disposed parallel to the vertical axis VL. The first upper supporter 46a may be referred to as a center supporter 46a.

A second upper supporter 46b may be adjacent to the first boundary Bo1 may be disposed in a direction intersecting the longitudinal direction of the diaphragm 41. The second upper supporter 46b may be located below the first boundary Bo1 and may be disposed parallel to the first boundary Bo1. In this case, the first upper supporter 46a may be spaced 90 degrees apart from the second upper supporter 46b in a clockwise direction with respect to the first center of curvature 01. Alternatively, the second upper supporter 46b may be disposed between the first boundary Bo1 and one side of the first upper supporter 46a and may be disposed radially with respect to the first center of curvature 01.

A third upper supporter 46c may be adjacent to the first boundary Bo1 may be disposed in a direction intersecting the longitudinal direction of the diaphragm 41. The third upper supporter 46c may be located below the first boundary Bo1 and may be disposed parallel to the first boundary Bo1. In this case, the first upper supporter 46a may be spaced 90 degrees apart from the third upper supporter 46b in a counterclockwise direction with respect to the first center of curvature 01. Alternatively, the third upper supporter 46c may be disposed between the first boundary Bo1 and another side of the first upper supporter 46a and may be disposed radially with respect to the first center of curvature 01.

Referring back to FIGS. 7 and 8, a lower supporter 47 may be adjacent to the lower end of the diaphragm 41 and may protrude from one surface of the passive radiator 40 in the thickness direction of the passive radiator 40. The lower supporter 47 may be made of the same material as that of the passive radiator 40 and may be formed as one body with the passive radiator 40. The upper supporter 47 may be positioned or aligned radially with respect to the second center of curvature 02. The lower supporter 47 may be formed on the diaphragm 41, the flange 42, and the groove 43. The lower supporter 47 may be referred to as a lower weight 47. The lower supporter 47 may include a first part 471, a second part 472, and a third part 473. A length Lr of the lower supporter 47 may be 21.5 mm.

The first part 471 may protrude from one surface of the diaphragm 41 in the thickness direction of the diaphragm 41. The second part 472 may protrude from one surface of the flange 42 in the thickness direction of the flange 42. The third part 473 may protrude from one surface of the groove 43 in the thickness direction of the groove 43. The first part 471 and the second part 472 may have a flat block shape. The third part 473 may have a curved shape along the groove 43, and may connect the first part 471 and the second part 472. The first part 471, the second part 472, and the third part 473 may be substantially in the shape of the Greek letter omega.

The first part 471, the second part 472, and the third part 473 may be formed as one body. The first part 471, the second part 472, and the third part 473 may be formed as one body with the diaphragm 41, the flange 42, and the groove 43, respectively.

Further, a thickness Tr4 of the first part 471, a thickness Tr5 of the second part 472, and a thickness Tr6 of the third part 473 may be equal to or different from each other. For example, the thickness Tr4 of the first part 471 may be a minimum thickness of the lower supporter 47. For example, a distance Dt between the first part 471 and the second part 472 may be equal to a value obtained by subtracting twice the thickness Tr6 of the third part 473 from the width Dr of the groove 43.

In addition, the width of the first part 471, the width of the second part 472, and the width of the third part 473 may be equal to (see Wr of FIG. 8) or different from each other. For example, the width Wr may range from 4 mm to 10 mm. For example, the width Wr may be 5 mm.

For example, a plurality of lower supporters 47 may be spaced apart from each other in a circumferential direction of the second curved section 40C. For example, an angle between the plurality of lower supporters 47 may be constant in the circumferential direction of the second curved section 40C. For example, an angle between the three lower supporters 47a, 47b, and 47c may be 90 degrees in the circumferential direction of the second curved section 40C.

A first lower supporter 47a may be located on the vertical axis VL and may be disposed parallel to the vertical axis VL. The first lower supporter 47a may be referred to as a center supporter 46a.

A second lower supporter 47b may be adjacent to the second boundary Bo2 may be disposed in a direction intersecting the longitudinal direction of the diaphragm 41. The second lower supporter 47b may be located below the second boundary Bo2 and may be disposed parallel to the second boundary Bo2. In this case, the first lower supporter 47a may be spaced 90 degrees apart from the second lower supporter 47b in a counterclockwise direction with respect to the second center of curvature 02. Alternatively, the second lower supporter 47b may be disposed between the second boundary Bo2 and one side of the first lower supporter 47a and may be disposed radially with respect to the second center of curvature 02.

A third lower supporter 47c may be adjacent to the second boundary Bo2 and may be disposed in a direction intersecting the longitudinal direction of the diaphragm 41. The third lower supporter 47c may be located below the second boundary Bo2 and may be disposed parallel to the second boundary Bo2. In this case, the first lower supporter 47a may be spaced 90 degrees apart from the third lower supporter 47c in a clockwise direction with respect to the second center of curvature 02. Alternatively, the third lower supporter 47c may be disposed between the second boundary Bo2 and another side of the first lower supporter 47a and may be disposed radially with respect to the second center of curvature 02.

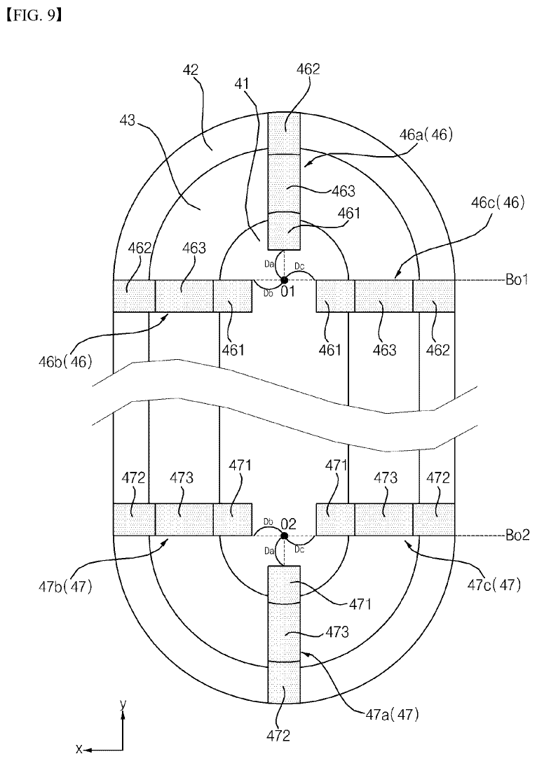

Referring to FIGS. 9 to 13, the upper supporter 46 may be disposed at or adjacent to the upper end of the passive radiator 40, and the lower supporter 47 may be disposed at or adjacent to the lower end of the passive radiator 40. As described above, the supporters 46 and 47 may be provided at both ends of the passive radiator 40 or at portions adjacent thereto, and may not be provided at other portions of the passive radiator 40. That is, the passive radiator 40 does not include a supporter between the upper supporter 46 and the lower supporter 47. In other words, the passive radiator 40 may have a constant cross-section between the upper supporter 46 and the lower supporter 47.

In addition, the upper supporter 46 and the lower supporter 47 may be vertically symmetrical. That is, the description of the upper supporter 46 may be symmetrically applied to the lower supporter 47.

Referring to FIG. 9, for example, the first part 461 of the first upper supporter 46a may be disposed on one surface of the diaphragm 41, and the second part 462 of the first upper supporter 46a that is opposite to the first part 461 may be disposed on one surface of the flange 42. The first part 461 may be spaced a first distance Da apart from the first center of curvature 01 in a direction from the first part 461 toward the second part 462.

In addition, the second upper supporter 46b and the third upper supporter 47c may be spaced apart from each other in the longitudinal direction of the first boundary Bo1, and the first center of curvature 01 may be located between the second upper supporter 46b and the third upper supporter 47c.

Specifically, the first part 461 of the second upper supporter 46b may be disposed on one surface of the diaphragm 41, and the second part 462 of the second upper supporter 46b that is opposite to the first part 461 may be disposed on one surface of the flange 42. The first part 461 may be spaced a second distance Db apart from the first center of curvature 01 in a direction from the first part 461 toward the second part 462.

Specifically, the first part 461 of the third upper supporter 46c may be disposed on one surface of the diaphragm 41, and the second part 462 of the third upper supporter 46c that is opposite to the first part 461 may be disposed on one surface of the flange 42. The first part 461 may be spaced a third distance Dc apart from the first center of curvature 01 in a direction from the first part 461 toward the second part 462.

For example, the first distance Da, the second distance Db, and the third distance Dc may be substantially equal to or different from each other.

Accordingly, the upper supporter 46 and the lower supporter 47 may minimize rolling of the passive radiator 40 that vibrates in response to the operation of the speaker 10 (see FIG. 2). Here, the rolling may refer to a rotational motion about the vertical axis VL (see FIG. 8) of the passive radiator 40. In addition, the upper supporter 46 and the lower supporter 47 may minimize pitching of the passive radiator 40 that vibrates in response to the operation of the speaker 10. Here, the pitching may refer to a rotational motion about the horizontal axis HL (see FIG. 8) of the passive radiator 40. That is, the passive radiator 40 including the supporters 46 and 47 may vibrate uniformly (see the bidirectional arrow indicating vibration in the thickness direction of the passive radiator 40 of FIG. 2) in response to the operation of the speaker 10 (see FIG. 2), and may have excellent low-frequency sound reproduction characteristics.

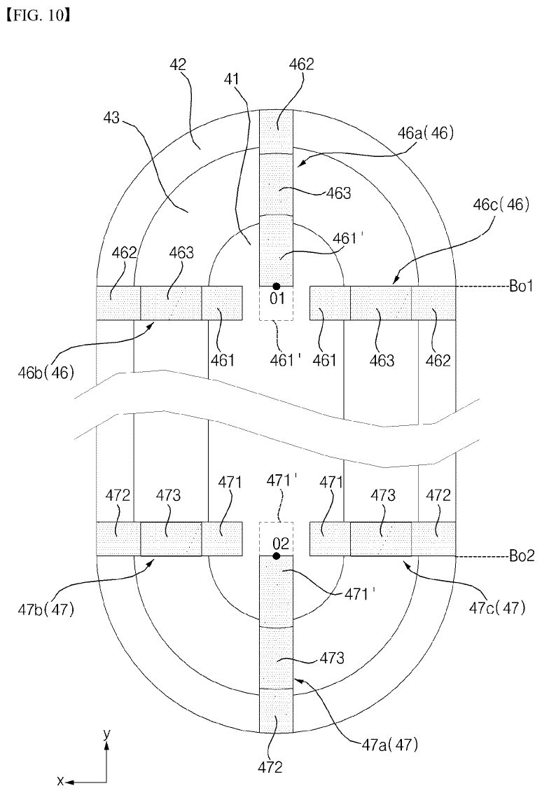

Referring to FIG. 10, for example, a first part 461′ of the first upper supporter 46a may be adjacent to or disposed on the first boundary Bo1 (see the solid line of FIG. 10). Alternatively, a portion of the first part 461′ of the first upper supporter 46a may be located below the first boundary Bo1 and may be disposed between the second upper supporter 46b and the third upper supporter 46c (see the dotted line of FIG. 10). In this case, the first part 461 of the second upper supporter 46b and the first part 461 of the third upper supporter 46c may be opposite each other with respect to the portion of first part 461′, and may be spaced apart from the portion of the first part 461′.

Accordingly, the upper supporter 46 and the lower supporter 47 may minimize rolling of the passive radiator 40 that vibrates in response to the operation of the speaker 10 (see FIG. 2). Here, the rolling may refer to a rotational motion about the vertical axis VL (see FIG. 8) of the passive radiator 40. In addition, the upper supporter 46 and the lower supporter 47 may minimize pitching of the passive radiator 40 that vibrates in response to the operation of the speaker 10. Here, the pitching may refer to a rotational motion about the horizontal axis HL (see FIG. 8) of the passive radiator 40. That is, the passive radiator 40 including the supporters 46 and 47 may vibrate uniformly (see the bidirectional arrow indicating vibration in the thickness direction of the passive radiator 40 of FIG. 2) in response to the operation of the speaker 10 (see FIG. 2), and may have excellent low-frequency sound reproduction characteristics.

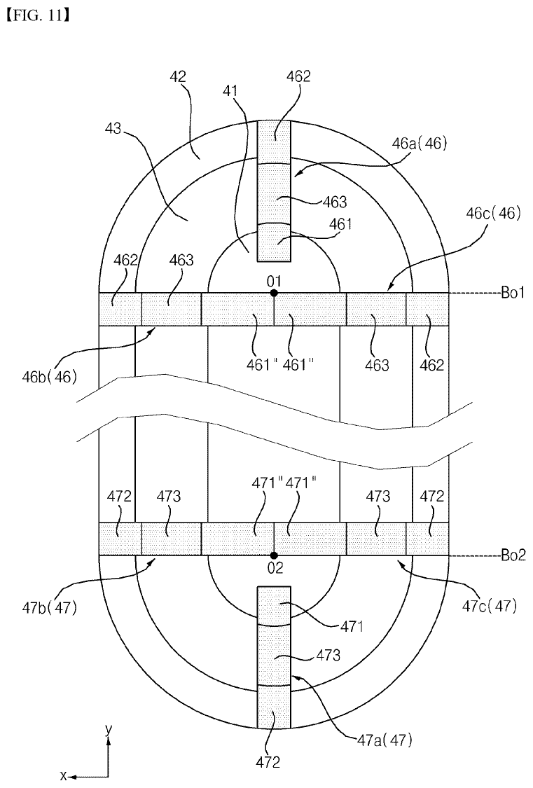

Referring to FIG. 11, for example, a distal end of a first part 461″ of the second upper supporter 46b may be located at the first center of curvature 01, and a distal end of a first part 461″ of the third upper supporter 46c may be located at the first center of curvature 01. That is, the first part 461″ of the second upper supporter 46b may contact, or may be formed as one body with, the first part 461″ of the third upper supporter 46c. In this case, the first part 461 of the first upper supporter 46a may be spaced apart from the first part 461″.

Accordingly, the upper supporter 46 and the lower supporter 47 may minimize rolling of the passive radiator 40 that vibrates in response to the operation of the speaker 10 (see FIG. 2). Here, the rolling may refer to a rotational motion about the vertical axis VL (see FIG. 8) of the passive radiator 40. In addition, the upper supporter 46 and the lower supporter 47 may minimize pitching of the passive radiator 40 that vibrates in response to the operation of the speaker 10. Here, the pitching may refer to a rotational motion about the horizontal axis HL (see FIG. 8) of the passive radiator 40. That is, the passive radiator 40 including the supporters 46 and 47 may vibrate uniformly (see the bidirectional arrow indicating vibration in the thickness direction of the passive radiator 40 of FIG. 2) in response to the operation of the speaker 10 (see FIG. 2), and may have excellent low-frequency sound reproduction characteristics.

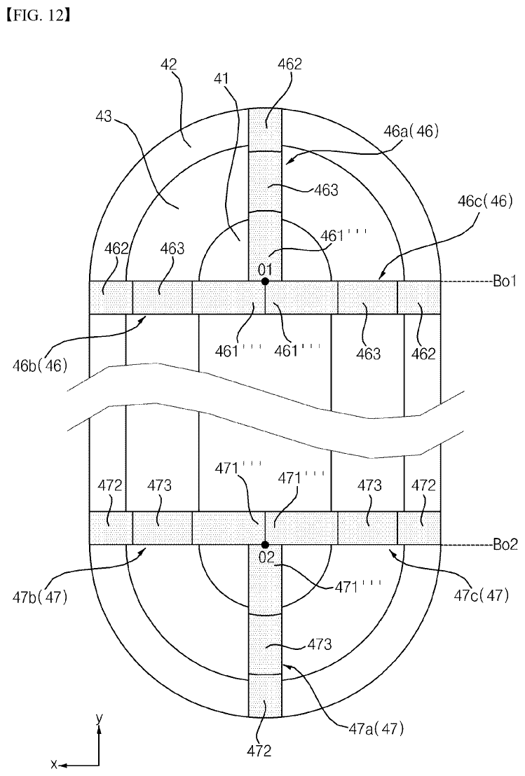

Referring to FIG. 12, for example, a distal end of a first part 461″ of the second upper supporter 46b may be located at the first center of curvature 01, and a distal end of a first part 461″ of the third upper supporter 46c may be located at the first center of curvature 01. That is, the first part 461″ of the second upper supporter 46b may contact, or may be formed as one body with, the first part 461″ of the third upper supporter 46c. In this case, a first part 461″′ of the first upper supporter 46a may be located on the first boundary Bo1. That is, the first part 461″′ of the first upper supporter 46a may contact, or may be formed as one body with, the first part 461″.

Accordingly, the upper supporter 46 and the lower supporter 47 may minimize rolling of the passive radiator 40 that vibrates in response to the operation of the speaker 10 (see FIG. 2). Here, the rolling may refer to a rotational motion about the vertical axis VL (see FIG. 8) of the passive radiator 40. In addition, the upper supporter 46 and the lower supporter 47 may minimize pitching of the passive radiator 40 that vibrates in response to the operation of the speaker 10. Here, the pitching may refer to a rotational motion about the horizontal axis HL (see FIG. 8) of the passive radiator 40. That is, the passive radiator 40 including the supporters 46 and 47 may vibrate uniformly (see the bidirectional arrow indicating vibration in the thickness direction of the passive radiator 40 of FIG. 2) in response to the operation of the speaker 10 (see FIG. 2), and may have excellent low-frequency sound reproduction characteristics.

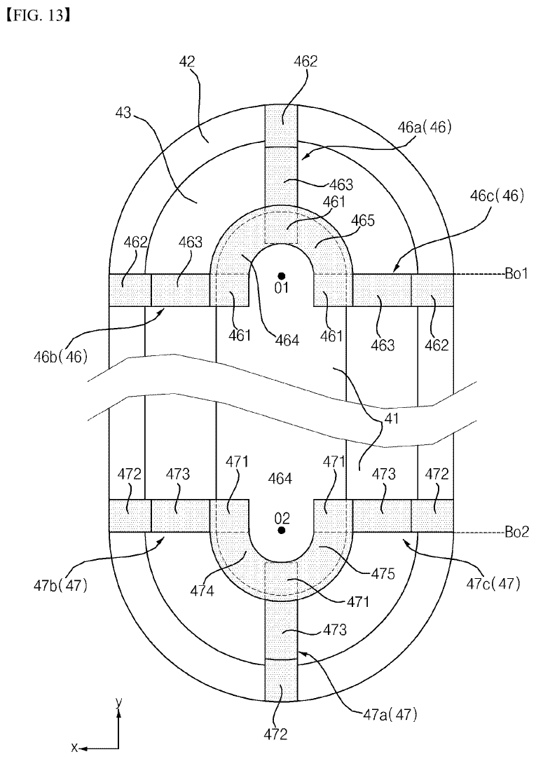

Referring to FIG. 13, for example, bridges 464 and 465 may connect the first upper supporter 46a, the second upper supporter 46b, and the third upper supporter 46c. A first bridge 464 may connect the first part 461 of the first upper supporter 46a and the first part 461 of the second upper supporter 46b, and may have a curved shape along the groove 43. A second bridge 465 may connect the first part 461 of the first upper supporter 46a and the first part 461 of the third upper supporter 46c, and may have a curved shape along the groove 43. The bridges 464 and 465 may be formed as one body with the first upper supporter 46a, the second upper supporter 46b, and the third upper supporter 46c.

Accordingly, the upper supporter 46 and the lower supporter 47 may minimize rolling of the passive radiator 40 that vibrates in response to the operation of the speaker 10 (see FIG. 2). Here, the rolling may refer to a rotational motion about the vertical axis VL (see FIG. 8) of the passive radiator 40. In addition, the upper supporter 46 and the lower supporter 47 may minimize pitching of the passive radiator 40 that vibrates in response to the operation of the speaker 10. Here, the pitching may refer to a rotational motion about the horizontal axis HL (see FIG. 8) of the passive radiator 40. That is, the passive radiator 40 including the supporters 46 and 47 may vibrate uniformly (see the bidirectional arrow indicating vibration in the thickness direction of the passive radiator 40 of FIG. 2) in response to the operation of the speaker 10 (see FIG. 2), and may have excellent low-frequency sound reproduction characteristics.

Referring to FIGS. 1 to 13, a sound device according to an embodiment of the present disclosure may include: a housing having an internal space; a speaker mounted at the housing; and a passive radiator spaced apart from the speaker and mounted at the housing, wherein the passive radiator may include: a diaphragm extending long, the diaphragm having a first end and a second end opposite each other in a longitudinal direction of the diaphragm; an edge extending along a perimeter of the diaphragm and coupled to the diaphragm and the housing; an upper supporter adjacent to the first end and protruding from the diaphragm and the edge; and a lower supporter adjacent to the second end and protruding from the diaphragm and the edge.

The speaker may be mounted at an upper surface or a lower surface of the housing, and the passive radiator may be mounted at a side surface of the housing, and the speaker and the passive radiator may define a portion of a boundary of the internal space of the housing.

A horizontal axis may pass through a center of the diaphragm and may extend in a width direction of the diaphragm, wherein the upper supporter may be symmetric to the lower supporter with respect to the horizontal axis.

The upper supporter may include a plurality of upper supporters disposed along in a perimeter direction of the diaphragm.

A portion of each of the plurality of upper supporters may be located on the diaphragm, and may be spaced apart from each other.

A portion of each of the plurality of upper supporters may be located on the diaphragm, and may be connected to each other at least two by two.

The plurality of upper supporters may include: a first upper supporter located at a longitudinal axis of the diaphragm and disposed parallel to the longitudinal axis; a second upper supporter which, in the perimeter direction of the diaphragm, is spaced apart from the first upper supporter in a first direction; and a third upper supporter which, in the perimeter direction of the diaphragm, is spaced apart from the first upper supporter in a second direction opposite the first direction.

The passive radiator may include: a straight section extending in a longitudinal direction of the diaphragm; and a first curved section connected to the straight section and including a portion of the diaphragm that defines the first end, wherein the second upper supporter and the third upper supporter may be adjacent to a first boundary which is a boundary between the straight section and the first curved section.

The second upper supporter and the third upper supporter may be located below the first boundary and may belong to the straight section.

The edge may include: a flange spaced apart from the diaphragm and fixed to the housing; and a groove located between the diaphragm and the flange and connecting the diaphragm and the flange, wherein in the first curved section, the diaphragm may have a semicircular shape that is convex in a direction opposite the straight section, and the flange and the groove may have a curved shape along the circumference of the diaphragm in the first curved section.

Each of the plurality of upper supporters may include: a first part protruding from one surface of the diaphragm in a thickness direction of the diaphragm; a second part protruding from one surface of the flange in a thickness direction of the flange; and a third part protruding from one surface of the groove in a thickness direction of the groove, wherein the first part, the second part, and the third part may be formed as one body.

The diaphragm may include: a core including a metal material; and a cover covering the core, wherein the cover, the edge, the upper supporter, and the lower supporter may be formed as one body.

The passive radiator may have a constant cross-section between the upper supporter and the lower supporter.

Certain embodiments or other embodiments of the disclosure described above are not mutually exclusive or distinct from each other. Any or all elements of the embodiments of the disclosure described above may be combined or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

The foregoing embodiments are merely examples and are not to be considered as limiting the present disclosure. The scope of the present disclosure should be determined by rational interpretation of the appended claims, and all modifications within the equivalents of the disclosure are intended to be included within the scope of the present disclosure.

What is claimed is:

1. A sound device comprising:
a housing having an internal space;
a speaker mounted at the housing; and
a passive radiator spaced apart from the speaker and mounted at the housing,
wherein the passive radiator comprises:
a diaphragm extending long, the diaphragm having a first end and a second end opposite each other in a longitudinal direction of the diaphragm;
an edge extending along a perimeter of the diaphragm and coupled to the diaphragm and the housing;
an upper supporter adjacent to the first end and protruding from the diaphragm and the edge; and
a lower supporter adjacent to the second end and protruding from the diaphragm and the edge.

2. The sound device of claim 1, wherein the speaker is mounted at an upper surface or a lower surface of the housing,
wherein the passive radiator is mounted at a side surface of the housing,
wherein the speaker and the passive radiator define a portion of a boundary of the internal space of the housing.

3. The sound device of claim 1, wherein a horizontal axis passes through a center of the diaphragm and extends in a width direction of the diaphragm,
wherein the upper supporter is symmetric to the lower supporter with respect to the horizontal axis.

4. The sound device of claim 1, wherein the upper supporter comprises a plurality of upper supporters disposed along a perimeter direction of the diaphragm.

5. The sound device of claim 4, wherein a portion of each of the plurality of upper supporters is located on the diaphragm, and are spaced apart from each other.

6. The sound device of claim 4, wherein a portion of each of the plurality of upper supporters is located on the diaphragm, and are connected to each other at least two by two.

7. The sound device of claim 4, wherein the plurality of upper supporters comprise:
a first upper supporter located at a longitudinal axis of the diaphragm and disposed parallel to the longitudinal axis;
a second upper supporter which, in the perimeter direction of the diaphragm, is spaced apart from the first upper supporter in a first direction; and
a third upper supporter which, in the perimeter direction of the diaphragm, is spaced apart from the first upper supporter in a second direction opposite the first direction.

8. The sound device of claim 7, wherein the passive radiator comprises:
a straight section extending in a longitudinal direction of the diaphragm; and
a first curved section connected to the straight section and including a portion of the diaphragm that defines the first end, wherein the second upper supporter and the third upper supporter are adjacent to a first boundary which is a boundary between the straight section and the first curved section.

9. The sound device of claim 8, wherein the second upper supporter and the third upper supporter are located below the first boundary and belong to the straight section.

10. The sound device of claim 8, wherein the edge comprises:
a flange spaced apart from the diaphragm and fixed to the housing; and
a groove located between the diaphragm and the flange and connecting the diaphragm and the flange,
wherein, in the first curved section, the diaphragm has a semicircular shape that is convex in a direction opposite the straight section,
wherein, in the first curved section, the flange and the groove have a curved shape along the perimeter of the diaphragm.

11. The sound device of claim 10, wherein each of the plurality of upper supporters comprises:
a first part protruding from one surface of the diaphragm in a thickness direction of the diaphragm;
a second part protruding from one surface of the flange in a thickness direction of the flange; and
a third part protruding from one surface of the groove in a thickness direction of the groove,
wherein the first part, the second part, and the third part are formed as one body.
